(19) United States
(12) Patent Application Publication
(10) Pub. No.: US 2026/0212073 A1
(43) Pub. Date: Jul. 23, 2026

(54) BLASTING DAMAGE SIMULATION TECHNIQUE ADAPTIVE TO ON-SITE ROCK MASS

(71) Applicant: Changjiang River Scientific Research Institute of Changjiang Water Resources Commission, Wuhan (CN)

(72) Inventors: Yingguo HU, Wuhan (CN); Yuejun HUANG, Wuhan (CN); Meishan LIU, Wuhan (CN); Chenyang MA, Wuhan (CN); Chenyu XU, Wuhan (CN); Gengquan LI, Wuhan (CN); Rui NIE, Wuhan (CN); Yu RAO, Wuhan (CN)

(73) Assignee: Changjiang River Scientific Research Institute of Changjiang Water Resources Commission, Wuhan (CN)

(21) Appl. No.: 19/446,973

(22) Filed: Jan. 13, 2026

(30) Foreign Application Priority Data
Jan. 20, 2025 (CN) 202510086668.0

(51) Int. Cl. G06F 30/20; G01V 1/30

(52) U.S. Cl. CPC G06F 30/20; G01V 1/303

(57) ABSTRACT

The provided is a blasting damage simulation technique adaptive to an on-site rock mass, including following steps: establishing a functional relation between a blasting damage variable of a rock mass and an acoustic velocity of the rock mass as well as a functional relation between the blasting damage variable of the rock mass and a mechanical parameter of the rock mass; continuously conducting acoustic testing on the rock mass, and establishing a blasting damage constitutive relation adaptive to the on-site rock mass; respectively introducing a rock mass damage calculation input parameter incorporating a damage variable and the blasting damage constitutive relation incorporating time to blasting-damage numerical simulation to obtain a blasting damage model; and compiling the blasting damage model into a customized program of a user-specified format with a Fortran language, embedding the customized program into dynamic finite element software LSDYNA, and calculating and simulating blasting damage characteristics.

### CROSS-REFERENCE TO THE RELATED APPLICATIONS

This application is based upon and claims priority to Chinese Patent Application No. 202510086668.0, filed on Jan. 20, 2025, the entire contents of which are incorporated herein by reference.

### TECHNICAL FIELD

The present disclosure belongs to the technical field of geotechnical engineering, and in particular to a blasting damage simulation technique adaptive to an on-site rock mass.

### BACKGROUND

During blasting excavation of rock masses, blasting loads inevitably cause a certain degree of damage to retained rock masses near an excavation face, thereby affecting engineering stability. Acoustic testing methods for determining damage ranges of rock masses are time-consuming, laborious, and highly subjective. Therefore, to ensure the safety of blasting construction, it is of great significance to accurately and quickly predict the blasting damage ranges of rock masses, thereby proposing effective control measures. To this end, relevant scholars have conducted extensive research, proposed a series of rock mass blasting damage models, and predicted the blasting damage characteristics of rock masses through numerical simulation. Although these models have been developed for different rock mass conditions and have found certain applications in related research, their applicability and accuracy in specific practical engineering scenarios remain to be further explored and verified due to the complexity of parameter determination for rock masses and the lack of flexible adjustability. Therefore, a blasting-damage numerical simulation technique adaptive to on-site rock masses is desired to effectively control excavation blasting damage of the rock masses and to ensure the long-term operational safety of high rock slopes during excavation blasting.

### SUMMARY

In view of problems in the prior art, the present disclosure provides a blasting damage simulation technique adaptive to an on-site rock mass. The present disclosure can accurately predict blasting damage characteristics of the on-site rock mass. In order to solve the problems in the prior art, the present disclosure adopts the following technical solutions:

A blasting damage simulation technique adaptive to an on-site rock mass includes following steps:
step 1: establishing a functional relation between a blasting damage variable of a rock mass and an acoustic velocity of the rock mass as well as a functional relation between the blasting damage variable of the rock mass and a mechanical parameter of the rock mass, and establishing, in combination with a theoretical calculation method in elastic mechanics and a mathematical fitting method, an iterative relation between a physico-mechanical parameter to be input in blasting damage calculation and a damage variable;
step 2: continuously conducting acoustic testing on the rock mass to track variation characteristics in damage development of the rock mass and variation characteristics of the physico-mechanical parameter, establishing a mechanical relation of damage over time with a regression analysis method, performing fitting based on data from 8-10 rounds of the acoustic testing, taking an average in each fitting, and establishing a blasting damage constitutive relation adaptive to the on-site rock mass;
step 3: based on analysis results in the step 1 and the step 2, respectively introducing a rock mass damage calculation input parameter incorporating the damage variable and the blasting damage constitutive relation incorporating time to blasting-damage numerical simulation to obtain a blasting damage model, thereby realizing blasting damage calculation, and learning and adaptation for dynamic characteristics of the rock mass; and
step 4: compiling the blasting damage model into a customized program of a user-specified format with a Fortran language, embedding the customized program into dynamic finite element software LSDYNA through a secondary development interface, and calculating and simulating blasting damage characteristics of the rock mass.

The functional relation established between the blasting damage variable of the rock mass and the acoustic velocity of the rock mass in the step 1 is expressed as:

$$D = 1 - {( \frac{{v}_{P}}{{v}_{P 0}} )}^{2} \qquad ( 1 )$$

where D is the blasting damage variable of the rock mass, v_{P} is a measured acoustic velocity of the rock mass, and v_{P0} is an acoustic velocity of an undamaged rock mass;
the functional relation established based on a generalized Hoek-Brown criterion between the blasting damage variable of the rock mass and the mechanical parameter of the rock mass in the step 1 is expressed as:

$${σ}_{1} = {σ}_{3} + {{σ}_{c} ( {m}_{b} \frac{{σ}_{3}}{{σ}_{c}} + s )}^{a} \qquad ( 2 )$$

where σ₁ and σ₃ are respectively a maximum principal stress and a minimum principal stress of the rock mass, σ_{c} is a uniaxial compressive strength of the undamaged rock mass, and m_{b}, s, and a are material parameters of the rock mass that are associated with lithology and a structural plane of the rock mass, and can be respectively represented as:

$${m}_{b} = {m}_{i} exp ( \frac{GSI - 100}{28 - 14 D} ) \qquad ( 3 )$$

$$s = exp ( \frac{GSI - 100}{9 - 3 D} ) \qquad ( 4 )$$

$$a = \frac{1}{2} + \frac{1}{6} [ exp ( \frac{- GSI}{15} ) - exp ( \frac{- 20}{3} ) ] \qquad ( 5 )$$

where GSI is a geological strength index, D is the blasting damage variable of the rock mass, and characterizes weakening of the mechanical parameter of the rock mass caused by blasting excavation, and mᵢ is a hardness parameter of the undamaged rock; and
the functional relation between the blasting damage variable of the rock mass and the acoustic velocity of the rock mass as well as the functional relation between the blasting damage variable of the rock mass and the mechanical parameter of the rock mass are established according to Eqs. (1) to (5).

The step 2 specifically includes:
step 2.1: arranging 2-4 groups of acoustic testing holes in an on-site blasting zone, measuring acoustic velocities of the rock mass at different depths in each group of acoustic testing holes, and obtaining the acoustic velocities of the rock mass at different depths in each group of acoustic testing holes, and according to a criterion that an acoustic velocity of a damaged rock mass is less than the acoustic velocity of the undamaged rock mass, determining the acoustic velocity of the undamaged rock mass;
step 2.2: according to the measured acoustic velocities of the rock mass at the different depths in each group of acoustic testing holes and the determined acoustic velocity of the undamaged rock mass, calculating blasting damage variables of the rock mass at the different depths in each group of acoustic testing holes based on Eq. (1);
step 2.3: accumulating measured acoustic velocities of the rock mass at a same depth in a plurality of groups of acoustic testing holes and taking an average, accumulating calculated blasting damage variables of the rock mass at the same depth in the plurality of groups of acoustic testing holes and taking an average, performing fitting on an average for the measured acoustic velocities of the rock mass and an average for calculated blasting damage variables of the rock mass at the different depths in the acoustic testing hole, and obtaining an optimized functional relation between the blasting damage variable of the rock mass and the acoustic velocity of the rock mass:

$$D = {f}_{1} ( {v}_{p} ) \qquad ( 6 )$$

step 2.4: according to the measured acoustic velocities of the rock mass at the different depths in each group of acoustic testing holes and the determined acoustic velocity of the undamaged rock mass, calculating optimized blasting damage variables of the rock mass at the different depths in each group of acoustic testing holes based on Eq. (6), and further calculating material parameters m_{b} and material parameters s of the rock mass at the different depths in each group of acoustic testing holes based on Eqs. (3) to (4);
step 2.5: respectively accumulating calculated material parameters m_{b} and calculated material parameters s of the rock mass at the same depth in the plurality of groups of acoustic testing holes and taking an average for the calculated material parameters m_{b} and an average for the calculated material parameters s, accumulating calculated optimized blasting damage variables of the rock mass at the same depth in the plurality of groups of acoustic testing holes and taking an average, performing fitting on an average for the material parameters m_{b}, an average for the material parameters s, and an average for the optimized blasting damage variables of the rock mass at the different depths in the acoustic testing hole, and obtaining an optimized functional relation between the blasting damage variable of the rock mass and the material parameters m_{b} and s of the rock mass:

$${m}_{b} = {f}_{2} ( D ) \qquad ( 7 )$$

$$s = {f}_{3} ( D ) \qquad ( 8 )$$

step 2.6: continuously conducting the acoustic testing on 8-10 benches to track the variation characteristics in the damage development of the rock mass, establishing the mechanical relation of the damage over the time with the regression analysis method, performing the fitting based on data, taking the average in each fitting, and establishing the blasting damage constitutive relation adaptive to the on-site rock mass:

$$D = f ( t , {σ}_{1} , {σ}_{3} , {σ}_{c} , {m}_{i} , GSI ) . \qquad ( 9 )$$

The step 3 specifically includes: calculating a principal stress of the rock mass according to a characteristic equation of a stress state:

$${σ}_{n}^{3} - {I}_{1} {σ}_{n}^{2} - {I}_{2} {σ}_{n} - {I}_{3} = 0 \qquad ( 10 )$$

where σₙ represents the principal stress of the rock mass, and I₁, I₂, and I₃ are respectively an invariant of a first stress tensor, an invariant of a second stress tensor, and an invariant of a third stress tensor, and are respectively represented as:

$${I}_{1} = {σ}_{x} + {σ}_{y} + {σ}_{z} \qquad ( 11 )$$

$${I}_{2} = - {σ}_{x} {σ}_{y} - {σ}_{y} {σ}_{z} - {σ}_{z} {σ}_{x} + {τ}_{xy}^{2} + {τ}_{yz}^{2} + {τ}_{zx}^{2} \qquad ( 12 )$$

$${I}_{3} = {σ}_{x} {σ}_{y} {σ}_{z} + 2 {τ}_{xy} {τ}_{y z} {τ}_{zx} - {σ}_{x} {τ}_{yz}^{2} - {σ}_{y} {τ}_{zx}^{2} - {σ}_{z} {τ}_{xy}^{2} \qquad ( 13 )$$

where σₓ, σ_{y}, σ_{z}, τ_{xy}, τ_{yz}, and Tax are respectively six independent stress components of the rock mass;
sorting three real roots in Eq. (10) according to algebraic values to obtain the maximum principal stress σ₁ and the minimum principal stress σ₃ of the rock mass that are respectively represented as:

$${σ}_{1} = {g}_{1} ( {σ}_{1} , {σ}_{2} , {σ}_{3} , {τ}_{xy} , {τ}_{yz} , {τ}_{zx} ) \qquad ( 14 )$$

$${σ}_{3} = {g}_{2} ( {σ}_{1} , {σ}_{2} , {σ}_{3} , {τ}_{xy} , {τ}_{yz} , {τ}_{zx} ) \qquad ( 15 )$$

calculating the blasting damage variable D of the rock mass according to Eq. (9), Eq. (14), and Eq. (15) and correcting the blasting damage variable D; and if D≥1, setting D=1 and adding a failure criterion to specify an element failure;
based on the generalized Hoek-Brown criterion, calculating an elastic modulus

$$D = 1 - {( \frac{{v}_{P}}{{v}_{P 0}} )}^{2}$$

of the rock mass by:

$$\overline{E} = \{ \begin{matrix}( 1 - \frac{D}{2} ) \sqrt{\frac{{σ}_{c}}{100}} {10}^{( GSI - 10 ) / 40} , & {σ}_{c} \leq 100 MPa \\ ( 1 - \frac{D}{2} ) {10}^{( GSI - 10 ) / 40} , & {σ}_{c} > 100 MPa\end{matrix} \qquad ( 16 )$$

calculating a Poisson's ratio

$$D = 1 - {( \frac{{v}_{P}}{{v}_{P 0}} )}^{2}$$

of the rock mass by:

$$\overline{μ} = 0.42 - 0.032 \sqrt{1 - D} {v}_{p 0} \qquad ( 17 )$$

recording a damage effect of the rock under a blasting load according to an incremental Hooke's law:

$$d {σ}_{ij} = \overline{K} d {ε}_{kk} {δ}_{ij} + 2 \overline{G} d {e}_{ij} . \qquad ( 20 )$$

Before the establishing the blasting damage model, the blasting damage simulation technique adaptive to an on-site rock mass further includes: determining the uniaxial compressive strength σ_{c}, the hardness parameter mᵢ, and a GSI of the undamaged rock mass based on an engineering geological survey and a laboratory test on the physico-mechanical parameter of the rock mass.

The present disclosure has the following advantages:

(1) The present disclosure establishes the blasting damage simulation technique adaptive to the damage variable of the rock mass and the physico-mechanical parameter of the rock mass, and can accurately and dynamically reflect variation characteristics of the input physico-mechanical parameter of the rock mass under the action of the blasting damage.

(2) The present disclosure establishes the damage constitutive relation over the time, breaking through the technical bottleneck of assumed elasticity or ideal elastoplasticity adopted in traditional numerical calculation. Through adaptation and self-learning, the present disclosure can accurately predict blasting damage characteristics of the on-site rock mass, providing effective guidance for the safety design in practical engineering.

(3) The present disclosure dynamically integrates an on-site test result into the blasting damage simulation calculation, realizing the technical progresses of parameter verification and on-site comparative correction in numerical simulation calculation.

### BRIEF DESCRIPTION OF THE DRAWINGS

FIG. 1 is a schematic flowchart of blasting damage simulation adaptive to an on-site rock mass according to the present disclosure;

FIG. 2 illustrates an arrangement for acoustic testing on a rock mass in an adaptive simulation method according to the present disclosure; and

FIG. 3 is a schematic diagram of a constitutive relation adaptive to a rock mass according to the present disclosure.

### DETAILED DESCRIPTION OF THE EMBODIMENTS

The technical solutions of the present disclosure are further specifically described below with reference to the accompanying drawings through embodiments.

### Embodiment 1

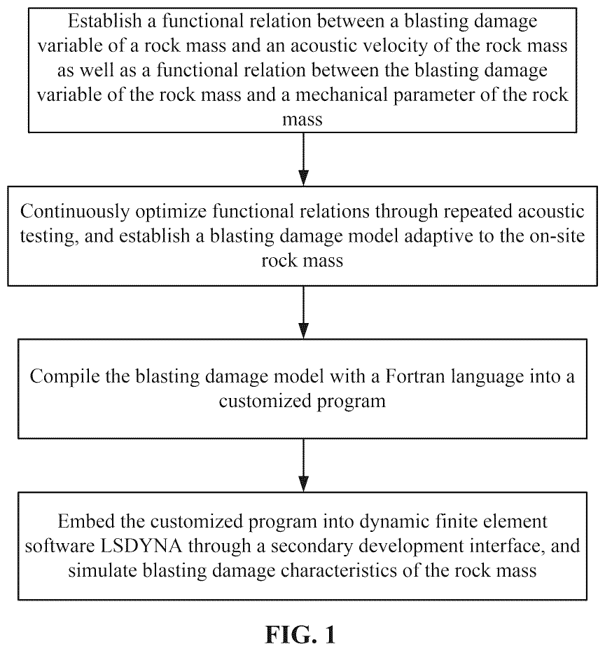

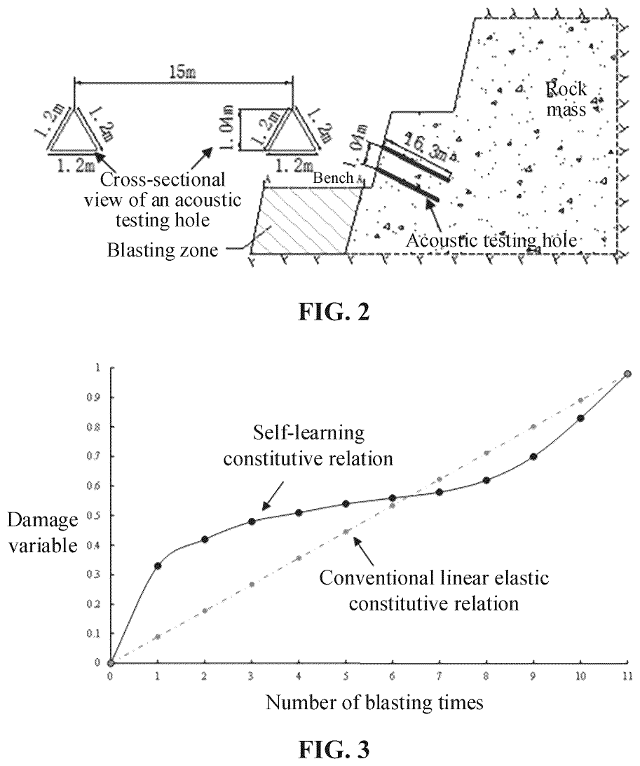

Taking a specific project as an example, in order to calculate a blasting damage distribution range of the rock mass, 10 benches are selected. Each bench is 10 m high, and the rock mass is basalt. Acoustic testing is conducted on the 10 benches from top to bottom, with a schematic diagram shown in FIG. 2. The acoustic testing is conducted before and after blasting, and an acoustic attenuation rate of the rock mass is calculated each time. With the technical solutions of the present disclosure, blasting damage simulation adaptive to an on-site rock mass is performed. As shown in FIG. 1, it includes the following steps:
Step 1: A functional relation between a blasting damage variable of a rock mass and an acoustic velocity of the rock mass as well as a functional relation between the blasting damage variable of the rock mass and a mechanical parameter of the rock mass are established.
Step 2: Acoustic testing is continuously conducted on the rock mass to track variation characteristics in damage development of the rock mass and variation characteristics of a physico-mechanical parameter of the rock mass, a mechanical relation of damage over time is established with a regression analysis method, fitting is performed based on data from 8-10 rounds of the acoustic testing, an average is taken in each fitting, and a blasting damage constitutive relation adaptive to the on-site rock mass is established, as shown in FIG. 3.
Step 3: A rock mass damage calculation parameter incorporating the damage variable is taken as an input parameter, and a mathematical equation of a rock mass blasting damage variation curve incorporating time is taken as a constitutive relation.
Step 4: A blasting damage model is compiled into a customized program of a user-specified format with a Fortran language, the customized program is embedded into dynamic finite element software LSDYNA through a secondary development interface, and blasting damage characteristics of the rock mass are calculated and simulated.

The protection scope of the present disclosure is not limited to the above embodiments. Apparently, those skilled in the art can make various modifications and variations to the present disclosure without departing from the scope and spirit of the present disclosure. Provided that these modifications and variations of the present disclosure fall within the scope of the claims of the present disclosure and their equivalents, the present disclosure will also be intended to include these modifications and variations.

What is claimed is:

1. A blasting damage simulation technique adaptive to an on-site rock mass, comprising following steps:
step 1: establishing a functional relation between a blasting damage variable of a rock mass and an acoustic velocity of the rock mass as well as a functional relation between the blasting damage variable of the rock mass and a mechanical parameter of the rock mass, and establishing, in combination with a theoretical calculation method in elastic mechanics and a mathematical fitting method, an iterative relation between a physico-mechanical parameter and a damage variable that are to be input in blasting damage calculation;
step 2: continuously conducting acoustic testing on the rock mass to track variation characteristics in damage development of the rock mass and variation characteristics of the physico-mechanical parameter, establishing a mechanical relation of damage over time with a regression analysis method, performing fitting based on data from 8-10 rounds of the acoustic testing, taking an average in each fitting, and establishing a blasting damage constitutive relation adaptive to the on-site rock mass;
step 3: based on the step 1 and the step 2, respectively introducing a rock mass damage calculation input parameter incorporating the damage variable and the blasting damage constitutive relation incorporating time to blasting-damage numerical simulation to obtain a blasting damage model, thereby realizing blasting damage calculation, and learning and adaptation for dynamic characteristics of the rock mass; and
step 4: compiling the blasting damage model into a customized program of a user-specified format with a Fortran language, embedding the customized program into dynamic finite element software LSDYNA through a secondary development interface, and calculating and simulating blasting damage characteristics of the rock mass, wherein
the functional relation established between the blasting damage variable of the rock mass and the acoustic velocity of the rock mass in the step 1 is expressed as:
$$D = 1 - {( \frac{{v}_{P}}{{v}_{P 0}} )}^{2} \qquad ( 1 )$$
wherein D is the blasting damage variable of the rock mass, v_{P} is a measured acoustic velocity of the rock mass, and v_{P0} is an acoustic velocity of an undamaged rock mass;
the functional relation established based on a generalized Hoek-Brown criterion between the blasting damage variable of the rock mass and the mechanical parameter of the rock mass in the step 1 is expressed as:
$${σ}_{1} = {σ}_{3} + {{σ}_{c} ( {m}_{b} \frac{{σ}_{3}}{{σ}_{c}} + s )}^{a} \qquad ( 2 )$$
wherein σ₁ and σ₃ are respectively a maximum principal stress and a minimum principal stress of the rock mass, σ_{c} is a uniaxial compressive strength of the undamaged rock mass, and m_{b}, s, and a are material parameters of the rock mass that are associated with lithology and a structural plane of the rock mass, and are respectively represented as:
$${m}_{b} = {m}_{1} exp ( \frac{G S I - 100}{28 - 14 D} ) \qquad ( 3 )$$
$$s = exp ( \frac{G S I - 100}{9 - 3 D} ) \qquad ( 4 )$$
$$a = \frac{1}{2} + \frac{1}{6} [ exp ( \frac{- G S I}{15} ) - exp ( \frac{- 20}{3} ) ] \qquad ( 5 )$$
wherein GSI is a geological strength index, D is the blasting damage variable of the rock mass, and characterizes weakening of the mechanical parameter of the rock mass caused by blasting excavation, and mᵢ is a hardness parameter of the undamaged rock mass; and
the functional relation between the blasting damage variable of the rock mass and the acoustic velocity of the rock mass as well as the functional relation between the blasting damage variable of the rock mass and the mechanical parameter of the rock mass are established according to Eqs. (1) to (5).

2. The blasting damage simulation technique adaptive to the on-site rock mass according to claim 1, wherein the step 2 specifically comprises:
step 2.1: arranging 2-4 groups of acoustic testing holes in an on-site blasting zone, measuring acoustic velocities of the rock mass at different depths in each group of acoustic testing holes, and obtaining the acoustic velocities of the rock mass at different depths in each group of acoustic testing holes, and according to a criterion that an acoustic velocity of a damaged rock mass is less than the acoustic velocity of the undamaged rock mass, determining the acoustic velocity of the undamaged rock mass;
step 2.2: according to the measured acoustic velocities of the rock mass at the different depths in each group of acoustic testing holes and the determined acoustic velocity of the undamaged rock mass, calculating blasting damage variables of the rock mass at the different depths in each group of acoustic testing holes based on Eq. (1);
step 2.3: accumulating measured acoustic velocities of the rock mass at a same depth in a plurality of groups of acoustic testing holes and taking an average, accumulating calculated blasting damage variables of the rock mass at the same depth in the plurality of groups of acoustic testing holes and taking an average, performing fitting on an average for the measured acoustic velocities of the rock mass and an average for the calculated blasting damage variables of the rock mass at the different depths in the acoustic testing hole, and obtaining an optimized functional relation between the blasting damage variable of the rock mass and the acoustic velocity of the rock mass:
$$D = {f}_{1} ( {v}_{p} ) \qquad ( 6 )$$
step 2.4: according to the measured acoustic velocities of the rock mass at the different depths in each group of acoustic testing holes and the determined acoustic velocity of the undamaged rock mass, calculating optimized blasting damage variables of the rock mass at the different depths in each group of acoustic testing holes based on Eq. (6), and further calculating material parameters m_{b} and material parameters s of the rock mass at the different depths in each group of acoustic testing holes based on Eqs. (3) to (4);
step 2.5: respectively accumulating calculated material parameters m_{b} and calculated material parameters s of the rock mass at the same depth in the plurality of groups of acoustic testing holes and taking an average for the calculated material parameters m_{b} and an average for the calculated material parameters s, accumulating calculated optimized blasting damage variables of the rock mass at the same depth in the plurality of groups of acoustic testing holes and taking an average, performing fitting on an average for the material parameters m_{b}, an average for the material parameters s, and an average for the optimized blasting damage variables of the rock mass at the different depths in the acoustic testing hole, and obtaining an optimized functional relation between the blasting damage variable of the rock mass and the material parameters m_{b} and s of the rock mass:
$${m}_{b} = {f}_{2} ( D ) \qquad ( 7 )$$
$$s = {f}_{3} ( D ) \qquad ( 8 )$$
step 2.6: continuously conducting the acoustic testing on 8-10 benches to track the variation characteristics in the damage development of the rock mass, establishing the mechanical relation of the damage over the time with the regression analysis method, performing the fitting based on data, taking the average in each fitting, and establishing the blasting damage constitutive relation adaptive to the on-site rock mass:
$$D = f ( t , {σ}_{1} , {σ}_{3} , {σ}_{c} , {m}_{i} , G SI ) . \qquad ( 9 )$$

3. The blasting damage simulation technique adaptive to the on-site rock mass according to claim 2, wherein the step 3 specifically comprises: calculating a principal stress of the rock mass according to a characteristic equation of a stress state:
$${σ}_{n}^{3} - {I}_{1} {σ}_{n}^{2} - {I}_{2} {σ}_{n} - {I}_{3} = 0 \qquad ( 10 )$$
wherein σₙ represents the principal stress of the rock mass, and I₁, I₂, and I₃ are respectively an invariant of a first stress tensor, an invariant of a second stress tensor, and an invariant of a third stress tensor, and are respectively represented as:
$${I}_{1} = {σ}_{x} + {σ}_{y} + {σ}_{z} \qquad ( 11 )$$
$${I}_{2} = - {σ}_{x} {σ}_{y} - {σ}_{y} {σ}_{z} - {σ}_{z} {σ}_{x} + {τ}_{xy}^{2} + {τ}_{yz}^{2} + {τ}_{zx}^{2} \qquad ( 12 )$$
$${I}_{3} = {σ}_{x} {σ}_{y} {σ}_{z} + 2 {τ}_{xy} {τ}_{yz} {τ}_{zx} - {σ}_{x} {τ}_{y z}^{2} - {σ}_{y} {τ}_{z x}^{2} - {σ}_{z} {τ}_{xy}^{2} \qquad ( 13 )$$
wherein σₓ, σ_{y}, σ_{z}, τ_{xy}, τ_{yz}, and τ_{zx} are respectively six independent stress components of the rock mass;
sorting three real roots in Eq. (10) according to algebraic values to obtain the maximum principal stress σ₁ and the minimum principal stress σ₃ of the rock mass that are respectively represented as:
$${σ}_{1} = {g}_{1} ( {σ}_{1} , {σ}_{2} , {σ}_{3} , {τ}_{xy} , {τ}_{yz} , {τ}_{zx} ) \qquad ( 14 )$$
$${σ}_{3} = {g}_{2} ( {σ}_{1} , {σ}_{2} , {σ}_{3} , {τ}_{xy} , {τ}_{yz} , {τ}_{zx} ) \qquad ( 15 )$$
calculating the blasting damage variable D of the rock mass according to Eq. (9), Eq. (14), and Eq. (15) and correcting the blasting damage variable D; and if D≥1, setting D=1 and adding a failure criterion to specify an element failure;
based on the generalized Hoek-Brown criterion, calculating an elastic modulus Ē of the rock mass by:
$$\overline{E} = \{ \begin{matrix}( 1 - \frac{D}{2} ) \sqrt{\frac{{σ}_{c}}{100}} {10}^{( GSI - 10 ) / 40} , {σ}_{c} \leq 100 MPa \\ ( 1 - \frac{D}{2} ) {10}^{( GSI - 10 ) / 40} , {σ}_{c} > 100 MPa\end{matrix} \qquad ( 16 )$$
calculating a Poisson's ratio μ̅ of the rock mass by:
$$\overline{μ} = 0.42 - 0.032 \sqrt{1 - D} {v}_{p 0} \qquad ( 17 )$$
recording a damage effect of the rock under a blasting load according to an incremental Hooke's law:
$$d {σ}_{ij} = \overline{K} d {ε}_{kk} {δ}_{ij} + 2 \overline{G} {de}_{ij} . \qquad ( 20 )$$

4. The blasting damage simulation technique adaptive to the on-site rock mass according to claim 1, before the establishing the blasting damage model adaptive to the on-site rock mass, further comprising: determining the uniaxial compressive strength σ_{c}, the hardness parameter mᵢ, and a GSI of the undamaged rock mass based on an engineering geological survey and a laboratory test on the physico-mechanical parameter of the rock mass.
